(19) United States
(12) Patent Application Publication
(10) Pub. No.: US 2025/0024427 A1
(43) Pub. Date: Jan. 16, 2025

(54) SERVICE EXPOSURE PROCESSING METHOD AND APPARATUS AND RELATED DEVICE

(71) Applicant: VIVO MOBILE COMMUNICATION CO., LTD., Dongguan (CN)

(72) Inventors: Yizhong ZHANG, Dongguan (CN); Wen WANG, Dongguan (CN)

(73) Assignee: VIVO MOBILE COMMUNICATION CO., LTD., Dongguan (CN)

(21) Appl. No.: 18/898,653

(22) Filed: Sep. 26, 2024

Related U.S. Application Data
(63) Continuation of application No. PCT/CN2023/084391, filed on Mar. 28, 2023.

(30) Foreign Application Priority Data
Mar. 29, 2022 (CN) 202210323862.2

(51) Int. Cl. H04W 64/00; G01S 5/02; H04W 12/06

(52) U.S. Cl. CPC H04W 64/006; G01S 5/0205; G01S 5/0284; H04W 12/06

(57) ABSTRACT

This application discloses service exposure processing methods and related devices. The service exposure processing method includes: receiving, by a first network side device, a target request message associated with a first service; and obtaining, by the first network side device, a first result. The first service includes at least one of a ranging service or a sidelink positioning service; and the first result is a result of executing the first service by a first terminal and a second terminal.

### CROSS-REFERENCE TO RELATED APPLICATIONS

This application is a continuation of International Application No. PCT/CN2023/084391, filed on Mar. 28, 2023, which claims priority to Chinese Patent Application No. 202210323862.2, filed on Mar. 29, 2022. The entire contents of each of the above-referenced applications are expressly incorporated herein by reference.

### TECHNICAL FIELD

This application pertains to the field of communication technologies, and in particular, to a service exposure processing method and apparatus and a related device.

### BACKGROUND

With the development of communication technologies, the introduction of a ranging service and a sidelink positioning service is currently under discussion. Ranging means determining a distance between two terminals and/or a direction between one terminal (that is, a target terminal) and another terminal (that is, an observation terminal) by using a direct device connection. In a three-dimensional case, the direction may include a horizontal direction and a vertical direction. In a ranging-based service, only a distance needs to be measured, or only a direction needs to be measured, or a distance and a direction may need to be measured. The ranging-based service can be used in a variety of vertical fields, such as consumer, smart home, smart city, intelligent transportation, intelligent retail, and industry 4.0. However, a ranging and sidelink positioning service is a new scenario. How a network side device exposes a ranging-based service of an application server is to be discussed. Therefore, how to expose the ranging service and the sidelink positioning service is to be discussed.

### SUMMARY

Embodiments of this application provide a service exposure processing method, so that a distance measurement service and a sidelink positioning service can be exposed.

According to a first aspect, a service exposure processing method is provided, including:
receiving, by a first network side device, a target request message associated with a first service, where the first service includes at least one of a ranging service or a sidelink positioning service; and
obtaining, by the first network side device, a first result, where the first result is a result of executing the first service by a first terminal and a second terminal.

According to a second aspect, a service exposure processing method is provided, including:
sending, by a target service device, a first request message associated with a first service to a first network side device, where the first service includes at least one of a ranging service or a sidelink positioning service; and
receiving, by the target service device, a first result from the first network side device, where the first result is a result of executing the first service by a first terminal and a second terminal.

According to a third aspect, a service exposure processing method is provided, including:
performing, by a first terminal, a target operation associated with a first service, where the target operation includes at least one of the following:
in a case that the first terminal is an observation terminal, the target operation includes: receiving a first reference signal from a second terminal, and obtaining second information based on the first reference signal, where the first reference signal is used to determine measurement information; or
in a case that the first terminal is a target terminal, the target operation includes: sending a second reference signal to a second terminal, where the second reference signal is used to determine measurement information; where
the second information is used to determine a first result, the first result is a result of executing the first service by the first terminal and the second terminal, and the second information includes the measurement information or a measurement result obtained through calculation based on the measurement information.

According to a fourth aspect, a service exposure processing apparatus is provided, including:
a first receiving module, configured to receive a target request message associated with a first service, where the first service includes at least one of a ranging service or a sidelink positioning service; and
an obtaining module, configured to obtain a first result, where the first result is a result of executing the first service by a first terminal and a second terminal.

According to a fifth aspect, a service exposure processing apparatus is provided, including:
a second sending module, configured to send a first request message associated with a first service to a first network side device, where the first service includes at least one of a ranging service or a sidelink positioning service; and
a second receiving module, configured to receive a first result from the first network side device, where the first result is a result of executing the first service by a first terminal and a second terminal.

According to a sixth aspect, a service exposure processing apparatus is provided and is applied to a first terminal, and includes:
an execution module, configured to perform a target operation associated with a first service, where the target operation includes at least one of the following:
in a case that the first terminal is an observation terminal, the target operation includes: receiving a first reference signal from a second terminal, obtaining measurement information, and sending second information to a first network side device; or
in a case that the first terminal is a target terminal, the target operation includes: sending a second reference signal to a second terminal, where the second reference signal is used to determine measurement information; and triggering the second terminal to send second information; where
the second information is used to determine a first result, the first result is a result of executing the first service by the first terminal and the second terminal, and the second information includes the measurement information or a measurement result obtained through calculation based on the measurement information.

According to a seventh aspect, a terminal is provided, where the terminal includes a processor and a memory, the memory stores a program or an instruction that can be run on the processor, and when the program or the instruction is executed by the processor, the steps of the method according to the third aspect are implemented.

According to an eighth aspect, a terminal is provided, where the terminal is a first terminal and includes a processor and a communication interface, the communication interface is configured to perform a target operation associated with a first service, and the target operation includes at least one of the following:
in a case that the first terminal is an observation terminal, the target operation includes: receiving a first reference signal from a second terminal, obtaining measurement information, and sending second information to a first network side device; or
in a case that the first terminal is a target terminal, the target operation includes: sending a second reference signal to a second terminal, where the second reference signal is used to determine measurement information; and triggering the second terminal to send second information; where
the second information is used to determine a first result, the first result is a result of executing the first service by the first terminal and the second terminal, and the second information includes the measurement information or a measurement result obtained through calculation based on the measurement information.

According to a ninth aspect, a network side device is provided, where the network side device includes a processor and a memory, the memory stores a program or an instruction that can be run on the processor, and when the program or the instruction is executed by the processor, the steps of the method according to the first aspect or the steps of the method according to the second aspect are implemented.

According to a tenth aspect, a network side device is provided, including a processor and a communication interface. The communication interface is configured to receive a target request message associated with a first service, where the first service includes at least one of a ranging service or a sidelink positioning service. The processor is configured to obtain a first result, where the first result is a result of executing the first service by a first terminal and a second terminal.

In some embodiments, the communication interface is configured to: send a first request message associated with a first service to a first network side device, where the first service includes at least one of a ranging service or a sidelink positioning service; and receive a first result from the first network side device, where the first result is a result of executing the first service by a first terminal and a second terminal.

According to an eleventh aspect, a communication system is provided, including a terminal, a network side device, and a target service device. The terminal may be configured to perform the steps of the service exposure processing method according to the third aspect, the network side device may be configured to perform the steps of the service exposure processing method according to the first aspect, and the target service device may be configured to perform the steps of the service exposure processing method according to the second aspect.

According to a twelfth aspect, a readable storage medium is provided. The readable storage medium stores a program or an instruction. When the program or the instruction is executed by a processor, the steps of the method according to the first aspect are implemented, the steps of the method according to the second aspect are implemented, or the steps of the method according to the third aspect are implemented.

According to a thirteenth aspect, a chip is provided. The chip includes a processor and a communication interface. The communication interface is coupled to the processor. The processor is configured to run a program or an instruction, to implement the steps of the method according to the first aspect, the steps of the method according to the second aspect, or the steps of the method according to the third aspect.

According to a fourteenth aspect, a computer program product/program product is provided. The computer program product/program product is stored in a storage medium, and the computer program/program product is executed by at least one processor to implement the steps of the method according to the first aspect, the steps of the method according to the second aspect, or the steps of the method according to the third aspect.

In the embodiments of this application, a first network side device receives a target request message associated with a first service, and the first network side device obtains a first result. In this way, the first network side device may directly interact the first result with an application server or an application function. Therefore, in the embodiments of this application, the first network side device may expose a ranging service and a sidelink positioning service for the application server or the application function.

### BRIEF DESCRIPTION OF DRAWINGS

FIG. 1 is a schematic diagram of a network structure to which this application is applicable;

FIG. 2 is a first flowchart of a service exposure processing method according to an embodiment of this application;

FIG. 3 is a second flowchart of a service exposure processing method according to an embodiment of this application;

FIG. 4 is a third flowchart of a service exposure processing method according to an embodiment of this application;

FIG. 5 is a fourth flowchart of a service exposure processing method according to an embodiment of this application;

FIG. 6 is a first structural diagram of a service exposure processing apparatus according to an embodiment of this application;

FIG. 7 is a second structural diagram of a service exposure processing apparatus according to an embodiment of this application;

FIG. 8 is a third structural diagram of a service exposure processing apparatus according to an embodiment of this application;

FIG. 9 is a schematic diagram of a structure of a communication device according to an embodiment of this application;

FIG. 10 is a schematic diagram of a structure of a terminal according to an embodiment of this application; and

FIG. 11 is a schematic diagram of a structure of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the term NR is used in most of the following description, although these technologies can also be applied to applications other than the NR system application, such as the 6th Generation (6G) communication system.

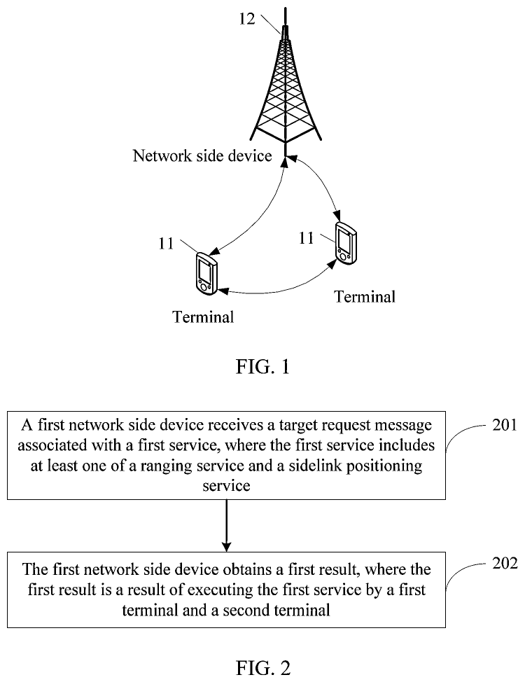

FIG. 1 is a block diagram of a wireless communication system to which the embodiments of this application may be applied. The wireless communication system includes a terminal 11 and a network side device 12. In some embodiments, the terminal 11 may be a terminal side device such as a mobile phone, a tablet personal computer, a laptop computer that is referred to as a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home device (a home device with a wireless communication function, such as a refrigerator, a television, a washing machine, or furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart ankle bracelet, a smart anklet chain, or the like), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Networks (WLAN) access point, a WiFi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another proper term in the art. The base station is not limited to a specific technical vocabulary provided that a same technical effect is achieved. It should be noted that in the embodiments of this application, a base station in an NR system is merely used as an example for description, but does not limit a specific type of the base station. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), Unified Data Repository (UDR), a Home Subscriber Server (HSS), Centralized network configuration (CNC), a Network Repository Function (NRF), a Network Exposure Function (NEF), a Local NEF or L-NEF, a Binding Support Function (BSF), an Application Function (AF), or the like. It should be noted that, in the embodiments of this application, only a core network device in the NR system is used as an example for description, and a specific type of the core network device is not limited.

For ease of understanding, some content involved in the embodiments of this application is described below.

A ranging service and a sidelink positioning service may be referred to as ranging-based services and sidelink positioning (Ranging based services and sidelink positioning).

Ranging means determining a distance between two terminals and/or a direction between one terminal (that is, a target terminal) and another terminal (that is, an observation terminal) by using a direct device connection. In a three-dimensional case, the direction may include a horizontal direction and a vertical direction. In a ranging-based service, only a distance needs to be measured, or only a direction needs to be measured, or a distance and a direction may need to be measured.

The ranging-based service can be used in a variety of vertical fields, such as consumer, smart home, smart city, intelligent transportation, intelligent retail, and industry 4.0.

For intelligent home television control: Based on a distance between a terminal and a television reference point, a direction from the television reference point to the terminal, and a direction from the terminal to the television reference point, an intelligent television may export a television screen area to which the terminal points, to determine a position of a cursor and content selected by a user.

For remote access permission authorization: A person may remotely monitor, by using a terminal 1 of the person, a distance between a visitor holding a terminal 2 and a door that can be ranged, to determine when to unlock the door to allow the visitor to access.

A service exposure processing method in the embodiments of this application is described in detail below with reference to the accompanying drawings by using specific embodiments and application scenarios thereof.

As shown in FIG. 2, an embodiment of this application provides a service exposure processing method. As shown in FIG. 2, the service exposure processing method includes the following steps:

Step 201: A first network side device receives a target request message associated with a first service, where the first service includes at least one of a ranging service or a sidelink positioning service.

Step 202: The first network side device obtains a first result, where the first result is a result of executing the first service by a first terminal and a second terminal.

In this embodiment of this application, the first network side device may include one or more network entities. For example, in some embodiments, the first network side device may be a Location Management Function (LMF). In some embodiments, the first network side device may be a device including network entities such as an LMF, an AMF, a PCF, a UDM, a UDR, an NEF, a Next Generation (NG) RAN, and a Gateway Mobile Location Centre (GMLC).

It should be understood that the target request message may be a first request message sent by a target service device to the first network side device, for example, the target request message may be a first request message sent by the target service device to a GMLC by using an NEF. For another example, in a case that the first network side device is an LMF, the target request message may be a third request message that is sent by an AMF when being triggered after the target service device sends the first request message to a GMLC by using an NEF.

The first terminal and the second terminal may be understood as a terminal associated with the first service or a terminal that executes the first service. The first terminal may be an observation terminal, may be a target terminal, or may be both an observation terminal and a target terminal. The second terminal may be an observation terminal, may be a target terminal, or may be both an observation terminal and a target terminal. The observation terminal is a terminal that receives a reference signal associated with the first service, or a terminal that obtains the first result. The target terminal may be understood as a terminal that sends the reference signal associated with the first service. For example, during one measurement of the reference signal, if the first terminal sends the reference signal to the second terminal, the first terminal is a target terminal, and the second terminal is an observation terminal; otherwise, the first terminal is an observation terminal, and the second terminal is a target terminal. In addition, when the first service is executed, one or more measurements may be performed. In different measurement processes, the first terminal may remain as a specific type of terminal (such as an observation terminal), or one or more types of switching may be performed (for example, including at least one of switching from an observation terminal to a target terminal or switching from a target terminal to an observation terminal).

In this embodiment of this application, the first network side device receives the target request message associated with the first service, and the first network side device obtains the first result. In this way, the first network side device may directly interact the first result with an application server or an application function. Therefore, in this embodiment of this application, the first network side device may expose the ranging service and the sidelink positioning service for the application server or the application function.

In some embodiments, in some embodiments, before the first network side device obtains the first result, the method further includes:

the first network side device sends first configuration information to a first target object based on the target request message, where the first target object includes at least one of the first terminal or the second terminal, and the first configuration information is used by the first target object to execute the first service.

In this embodiment of this application, the first configuration information is mainly used for a measurement process. In some embodiments, the first configuration information may be sent by the target service device to the first target object.

In some embodiments, specific content of the first configuration information may be set based on an actual requirement. For example, in some embodiments, the first configuration information may include at least one of the following:
reference signal information;
algorithm information;
service information;
a reference signal sending manner; or
a manner of determining a target result, where the target result is the first result or is determined based on the first result, and the target result includes at least one of the following: a relative distance between the first terminal and the second terminal, a relative angle between the first terminal and the second terminal, location information of the first terminal, or location information of the second terminal.

In some embodiments, the reference signal information may be understood as information indicating a reference signal used by the terminal when the first service is used. The reference signal information includes at least one of the following: a name of a reference signal, an identifier of the reference signal, a frequency of the reference signal, a period of the reference signal, power of the reference signal, or precision of the reference signal.

In some embodiments, the algorithm information includes at least one of the following: an algorithm name, an algorithm identifier, an algorithm parameter, or algorithm precision.

In some embodiments, the service information includes at least one of the following: a service code, a service identifier, or a service type.

In some embodiments, the reference signal sending manner includes at least one of the following: the first terminal sends a reference signal; the second terminal sends a reference signal; the first terminal and the second terminal sends a reference signal; a reference signal is sent immediately; a reference signal is sent periodically; or sending of a reference signal is sent by an event.

In some embodiments, the manner of determining the first result includes at least one of the following: the first terminal determines the target result; the second terminal determines the target result; the first terminal and the second terminal determine the target result; the first network side device determines the target result; or the target service device determines the target result.

In this embodiment of this application, when the target result is determined by the first terminal, it may be understood that the first terminal is an observation terminal; when the target result is determined by the second terminal, it may be understood that the second terminal is an observation terminal; when the target result is determined by the first terminal and the second terminal, it may be understood that the first terminal may be both an observation terminal and a target terminal, and the second terminal may also be both a target terminal and an observation terminal. For example, for a first reference signal sent by the first terminal to the second terminal, the first terminal is a target terminal, and the second terminal is an observation terminal; and for a second reference signal sent by the second terminal to the first terminal, the first terminal is an observation terminal, and the second terminal is a target terminal.

In some embodiments, in some embodiments, that the first network side device receives the target request message associated with the first service includes:

the first network side device receives a first request message from a target service device, where the target request message is the first request message, and the first request message is used to request at least one of the following:
obtaining the first result;
obtaining location information of the first terminal;
obtaining location information of the second terminal;
obtaining privacy information of the first terminal that is associated with the first service;
obtaining privacy information of the second terminal that is associated with the first service;
triggering the first terminal to execute the first service;
triggering the second terminal to execute the first service;
triggering the first terminal to obtain the first result; or
triggering the second terminal to obtain the first result.

In this embodiment of this application, the network side device is a device including network entities such as an LMF, an AMF, a PCF, a UDM, a UDR, an NEF, an NG-RAN, and a GMLC. The target service device may request both the location information of the first terminal and the location information of the second terminal by using one first request message, and then the target service device determines a relative distance and/or a relative angle between the first terminal and the second terminal based on the obtained location information. In some embodiments, the target service device may separately request the location information of the first terminal and the location information of the second terminal by using two first request messages, and then the target service device determines the relative distance and/or the relative angle between the first terminal and the second terminal based on the obtained location information.

It should be noted that in some embodiments, assuming that the first target object is in a Connection Management (CM) idle state, after receiving the first request message, the first network side device may send a network ranging service request to a terminal by using the AMF, so that a connection is established between the first target object and the first network side device. The first target object includes at least one of the first terminal or the second terminal.

In some embodiments, in some embodiments, after the first network side device receives the first request message from the target service device, the method further includes:
the first network side device sends a second request message to a first target object, where the first target object includes at least one of the first terminal or the second terminal, and the second request message is used to determine whether the first target object allows a first behavior;
the first network side device receives a second request response message sent by the first target object; and
the first network side device determines, based on the second request response message, whether the first target object allows the first behavior; where
the first behavior includes at least one of the following:
the first terminal and the second terminal execute the first service;
a target device obtains location information of a terminal;
a target device triggers a terminal to execute the first service; or
a target device obtains privacy information of a terminal that is associated with the first service.

In this embodiment of this application, whether the first behavior is allowed may be understood as whether the first behavior is supported. The terminal can execute the first service only when the terminal supports the first behavior. The second request message is sent to the first target object, to determine whether the terminal allows the first behavior. In this way, reliability of interaction between the first network side device and the terminal can be improved, and the terminal is prevented from executing the first service due to mis-triggering while the terminal does not support the first service.

It should be understood that the target device may be referred to as a third party or a third device.

In some embodiments, after the first network side device receives the first request message from the target service device, the method further includes:
the first network side device sends second configuration information to a first target object, where the first target object includes at least one of the first terminal or the second terminal, and the second configuration information is used to instruct to execute at least one of parameter information or authorization information used in a process associated with the first service.

In this embodiment of this application, a process associated with the first service may include a process of discovering a terminal.

In some embodiments, content carried in the first request message may be set based on an actual requirement. For example, in some embodiments, the first request message includes at least one of the following:
a terminal identifier of the first terminal, a terminal identifier of the second terminal, first indication information, second indication information, first service-related requirement information, or Quality of Service (QOS) information, where the first indication information is used to indicate that the first request message is used to request to obtain the first result, the second indication information is used to indicate a terminal that initiates the first service, and the requirement information includes at least one of the following: precision of the first result or a type of the first service.

In this embodiment of this application, the terminal that initiates the first service may be understood as an observation terminal or a target terminal.

In some embodiments, the type of the first service includes: immediately executing the first service; periodically executing the first service; and triggering execution of the first service by an event. For event triggering, for example, execution of the first service may be triggered when the first terminal and the second terminal are in a same tracking area (Tracking Area, TA) or a same cell (cell).

The precision of the first result may be understood as precision information of the first result. For example, during measurement of a relative distance value, the precision may be meter, decimeter, or centimeter; and during measurement of a relative angle, the precision may be degree, minute, or second.

It should be understood that, after receiving the first request message, the first network side device usually performs authentication on the first request message and feeds back an authentication result. For example, in some embodiments, after the first network side device receives the first request message from the target service device, the method further includes:

the first network side device sends a first request response message to the target service device, where the first request response message is used to indicate an authentication result for the first request message.

In this embodiment of this application, in a case that the first request response message indicates that the authentication succeeds, the target service device may determine that the first terminal and the second terminal can execute the first service, and can obtain the first result, to perform a subsequent operation. In a case that the first request response message indicates that the authentication fails, it may be understood as that a request of the first request message fails, the first terminal and the second terminal cannot be triggered to execute the first service, and cannot obtain the first result.

In some embodiments, in a case that the first network side device is a location management function LMF, that the first network side device receives the target request message associated with the first service includes:
the first network side device receives a third request message from an access and mobility management function AMF, where the target request message is the third request message, the third request message is used to request first configuration information of a first target object, and the first target object includes at least one of the first terminal or the second terminal.

In this embodiment of this application, the target service device may send the first request message to the GMLC, and after receiving the first request message, the GMLC may determine, based on information of the first terminal that is associated with the first service and information of the second terminal that is associated with the first service, whether the first terminal and the second terminal support execution of the first service. In a case that execution of the first service is supported, it is considered that authentication on the first request message succeeds, network address information of an AMF that provides a service for the first terminal and an AMF that provides a service for the second terminal is obtained, and an Namf_Location_ProvideRanging_Sidelink Positioning information request service operation is invoked from the AMF, to request ranging and/or sidelink positioning information of the first terminal and the second terminal. After receiving a request of the GMLC, the AMF may send the third request message to the LMF.

In some embodiments, message content carried in the third request message may be set based on an actual requirement. For example, in some embodiments, the third request message includes at least one of the following: a terminal identifier of the first terminal, a terminal identifier of the second terminal, capability information of the first terminal, or capability information of the second terminal; where
the capability information is used to indicate whether a terminal supports the first service.

In this embodiment of this application, the capability information may include a capability of supporting distance measurement and/or calculation, a capability of supporting direction measurement and/or calculation, a capability of supporting high-precision distance measurement and/or calculation, a capability of supporting high-precision direction measurement and/or calculation, and a capability of supporting calculation of the first service.

The terminal identifier may include at least one of the following:
an identity or a device identity of the terminal, which may be, for example, a Subscription Concealed Identifier (SUCI), a Globally Unique Temporary Identifier (GUTI), an International Mobile Subscriber Identity (IMSI), a Permanent Equipment Identifier (PEI), an International Mobile station Equipment Identity (IMEI), a Subscription Permanent Identifier (SUPI), a Temporary Mobile Subscription Identifier (TMSI), a Generic Public Subscription Identifier (GPSI), or a 5G System TMSI (5G-S-TMSI); or
a logical identifier of the terminal, where for example, the first network side device or the target service device may allocate a logical identifier that uniquely identifies the terminal, which may be, for example, a specific string combination, a layer 2 identifier (layer-2 ID), a terminal identifier related to service information, or address information of the terminal. The address information may include at least one of an IPV4 address, an IPV6 address, an IPV4v6 address, a port number, a Medium Access Control (MAC) address, or a Fully Qualified Domain Name (FQDN).

In some embodiments, in some embodiments, after the first network side device receives the target request message associated with the first service, the method further includes:
the first network side device determines an observation terminal and/or a target terminal, where
the observation terminal is a terminal that obtains the first result, the observation terminal includes at least one of the first terminal or the second terminal, the target terminal is a terminal that sends a reference signal, and the target terminal includes at least one of the first terminal and the second terminal.

In some embodiments, that the first network side device determines the observation terminal and/or the target terminal includes:
the first network side device determines the observation terminal and/or the target terminal based on target information, where
the target information includes at least one of the following: subscription information of a terminal, reachability of a terminal, capability information used to indicate whether a terminal supports the first service, location information of a terminal, or second indication information sent by a target service device, where the second indication information is used to indicate a terminal that initiates the first service.

In some embodiments, the location information may include at least one of absolute location information or relative location information.

The absolute location information includes at least one of the flowing: a TA, a registration area, a cell ID, longitude and latitude, altitude, a horizontal direction angle, or an elevation direction angle.

The relative location information may be at least one of a relative angle of the first terminal relative to the second terminal and an auxiliary node, or the relative angle may include a horizontal direction angle and an elevation direction angle. The auxiliary node may include another communication device other than the first terminal and the second terminal, for example, is a third terminal or a common infrastructure. The common infrastructure may include a road side unit. In some embodiments, the auxiliary node may be a common reference system, such as a street lamp, of which the first terminal and the second terminal know absolute location information.

In some embodiments, in some embodiments, the method further includes:
the first network side device sends a fourth request message to a first target object, where the first target object includes at least one of the first terminal or the second terminal, and the fourth request message is used to obtain at least one of the following:
the capability information;
the location information; or
requirement information related to the first service, where the requirement information includes at least one of the following: precision of the first result or a type of the first service.

It should be understood that, in this embodiment of this application, if the first network side device stores capability information, location information, and requirement information of the terminal, the first network side device does not send the fourth request message, and in a case that the first network side device lacks part of related information of the terminal, the first network side device may obtain the part of related information of the terminal by using the fourth request message.

In some embodiments, in some embodiments, after the first network side device obtains the first result, the method further includes any one of the following:
the first network side device sends the first result to a target service device; or
in a case that the first network side device is an LMF, the first network side device sends the first result to a target service device by using a second network side device, where the second network side device includes an access and mobility management function AMF, a gateway mobile location center GMLC, and a network exposure function NEF.

It should be noted that in this embodiment of this application, specific content of the first result may be set based on an actual requirement. For example, in some embodiments, the first result includes at least one of the following: a relative distance between the first terminal and the second terminal, a relative angle between the first terminal and the second terminal, location information of the first terminal, location information of the second terminal, or a second result, where the second result is an observation result obtained by the first terminal and/or the second terminal for a reference signal related to the first service.

In some embodiments, the second result includes at least one of first measurement information or second measurement information, the first measurement information is measurement information obtained, based on a second reference signal sent by the second terminal, by the first terminal when the first terminal executes the first service, and the second measurement information is measurement information obtained, based on a first reference signal sent by the first terminal, by the second terminal when the second terminal executes the first service.

In this embodiment of this application, in a case that the first result is a second result, the target service device may perform calculation based on the first result to determine at least one of the following: a relative distance between the first terminal and the second terminal, a relative angle between the first terminal and the second terminal, location information of the first terminal, or location information of the second terminal.

When the first result is at least one of the following: a relative distance between the first terminal and the second terminal, a relative angle between the first terminal and the second terminal, location information of the first terminal, or location information of the second terminal. The first result may be obtained by the terminal through calculation, or the first result may be obtained by a network side through calculation, or the first result may be obtained through calculation by both the terminal and the first network side device. For example, the terminal may obtain an initial first result through calculation, and the first network side device obtains a final first result through calculation based on the initial first result.

In some embodiments, in some embodiments, the method further includes:
the first network side device receives first information from a first target object, where the first information includes at least one of the following: third indication information, auxiliary information of a second target object that is associated with the first service, or a terminal identifier of the second target object, where the first target object includes at least one of the first terminal or the second terminal, the second target object is a first terminal or a second terminal in the first target object, and the third indication information is used to indicate at least one of the following:
a target device is allowed or not allowed to obtain location information of the second target object;
a target device is allowed or not allowed to trigger the second target object to execute the first service;
a target device is allowed or not allowed to trigger the second target object to obtain second information, where the second information is used to determine the first result; or
a target device is allowed or not allowed to obtain privacy information of the second target object that is associated with the first service.

It should be understood that, in this embodiment of this application, the first information may be actively reported by the terminal. For example, when registering with or accessing a network, the terminal may report the first information by using a Non-Access Stratum (NAS) message. In some embodiments, the first information may be actively obtained by the first network side device. For example, the first network side device requests the first information by using a request message, and then the terminal reports the first information based on the request message by using the NAS message. After receiving the first information, the first network side device may store the first information in the UDM or the UDR.

It should be noted that, when the first target object is the first terminal, the second target object is the first terminal; when the first target object is the second terminal, the second target object is the second terminal; and when the first target object includes the first terminal and the second terminal, the second target object is the first terminal or the second terminal.

In some embodiments, the first information may be carried by using any one of the following NAS messages: a registration request message, a terminal configuration update message, a Protocol Data Unit (PDU) session establishment message, a PDU session modification message, and a service request message.

In some embodiments, the auxiliary information includes at least one of the following: location information, address information, security information, reference signal information, measurement requirement information, capability information used to indicate whether the first service is supported, or algorithm information associated with the first service.

The security information includes an encryption key, a security parameter, and the like.

In some embodiments, the privacy information includes at least one of fourth indication information or a privacy type, and the fourth indication information is used to indicate at least one of the following:
the target device is allowed or not allowed to obtain the location information of the second target object;
the target device is allowed or not allowed to trigger the second target object to execute the first service;
the target device is allowed or not allowed to trigger the second target object to obtain the second information, where the second information is used to determine the first result; or
the target device is allowed or not allowed to obtain the privacy information of the second target object that is associated with the first service.

In some embodiments, in some embodiments, that the first network side device obtains the first result includes:
the first network side device receives second information; and
the first network side device determines the first result based on the second information, where
the second information includes at least one of the following:
first measurement information or a first measurement result, where the first measurement information is measurement information obtained, based on a second reference signal sent by the second terminal, by the first terminal when the first terminal executes the first service, and the first measurement result is a result obtained through calculation based on the first measurement information; or
second measurement information or a second measurement result, where the second measurement information is measurement information obtained, based on a first reference signal sent by the first terminal, by the second terminal when the second terminal executes the first service, and the second measurement result is a result obtained through calculation based on the second measurement information.

In this embodiment of this application, the first measurement result and/or the second measurement result may be understood as initial first results. When the second information includes only the first measurement result, the first network side device may determine the first measurement result as the first result. When the second information includes only the second measurement result, the first network side device may determine the second measurement result as the first result. When the second information includes only the first measurement information, the first network side device may determine the first measurement information as the first result, or obtain the first result through calculation based on the first measurement information. When the second information includes only the second measurement information, the first network side device may determine the second measurement information as the first result, or obtain the first result through calculation based on the second measurement information. When the second information includes the first measurement information and the second measurement information, the first network side device may obtain the first measurement result through calculation based on the first measurement information, obtain the second measurement result through calculation based on the second measurement information, and then determine the first result based on the first measurement result and the second measurement result. When the second information includes the first measurement result and the second measurement result, the first network side device may determine the first result based on the first measurement result and the second measurement result.

It should be understood that a manner in which the first network side device determines the first result based on the first measurement result and the second measurement result may be set based on an actual requirement, which may, for example, include the following cases:

Case 1: The first measurement result and the second measurement result may be determined as the first result. For example, the first measurement result includes a relative distance, the second measurement result includes a relative angle, and the first result includes the relative distance and the relative angle. For another example, the first measurement result includes a relative distance, the second measurement result includes a relative distance, and the first result includes the two relative distances. When the target service device determines a target result based on the first result, it may be understood that a final relative distance between the first terminal and the second terminal is determined based on the two relative distances.

Case 2: Averaging or weighted averaging may be performed on the first measurement result and the second measurement result to obtain the first result. For example, the first measurement result includes a relative distance, the second measurement result includes a relative distance, and the first result includes a final relative distance between the first terminal and the second terminal that is determined by calculating the two relative distances.

Case 3: One of the first measurement result and the second measurement result may be selected as the first result. For example, a measurement result with relatively high precision may be selected as the first result.

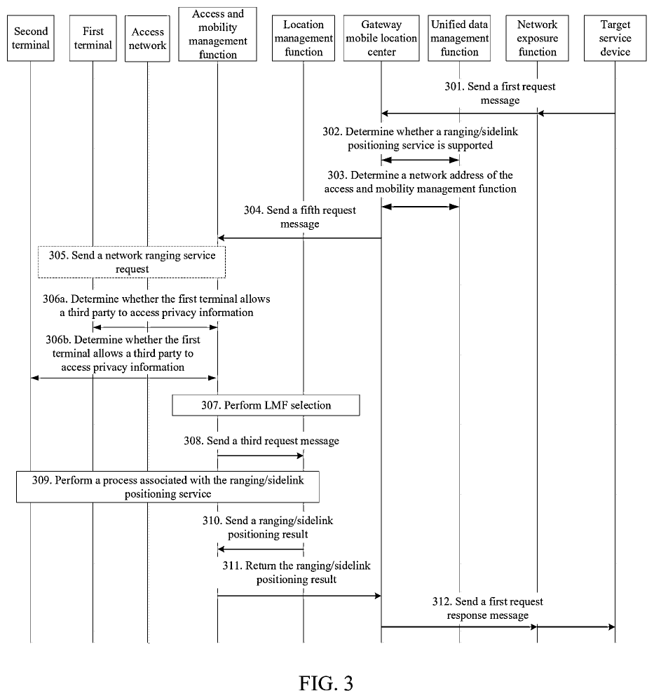

For better understanding of this application, divisional applications of this application are described below as examples. As shown in FIG. 3, for example, the following procedure is included:

Step 301: A target service device sends a first request message to a GMLC by using an NEF, where the first request message may include a terminal identifier of a first terminal and a terminal identifier of a second terminal.

Step 302: The GMLC interacts with a UDM to determine whether the first terminal and the second terminal support a ranging/sidelink positioning service, for example, invokes an Nudm_SDM_Get service operation for UDMs of the first terminal and the second terminal, to obtain the privacy setting of a terminal identified by GPSIs or SUPIs of the first terminal and the second terminal. The UDM returns the privacy setting. The GMLC checks a privacy profile of the ranging/sidelink positioning service of the terminal. If it is not allowed to perform the ranging/sidelink positioning service on the first terminal and the second terminal to obtain privacy information, step 303 to step 311 are skipped.

Step 303: The GMLC interacts with the UDM to determine a network address of an AMF. For example, the GMLC invokes an Nudm_UECM_Get service operation on the UDMs of the first terminal and the second terminal by using the GPSIs or the SUPIs of the first terminal and the second terminal. The UDM returns network addresses of current service AMFs of the first terminal and the second terminal.

Step 304: The GMLC sends a fifth request message to the AMF to request the ranging/sidelink positioning service. For example, the GMLC invokes an Namf_Location_ProvideRanging_Sidelink Positioning information request service operation from the AMF to request a ranging/sidelink positioning service result of the first terminal and the second terminal.

Step 305: The AMF sends a network ranging service request to the terminal to control the first terminal and the second terminal in an idle state to enter a connected state. For example, if the terminal is in a CM-IDLE state, the AMF starts a network-triggered service request program to establish a signaling connection to the terminal. This step is optional. Assuming that both the first terminal and the second terminal are in a connected state, a network ranging service request does not need to be sent.

Step 306: Send a second request message to the first terminal and the second terminal, so that the first terminal and the second terminal determine, by using a second request response message, whether a corresponding terminal allows a first behavior. In some embodiments, step 306 may include step 306a and step 306b. In step 306a, it is determined whether the first terminal allows a third party to access the privacy information. In step 306b, it is determined whether the first terminal allows the third party to access the privacy information. Step 306 may be understood as follows: If there is a privacy check requirement, the terminal needs to be notified or the terminal needs to be notified through privacy verification. The first terminal and the second terminal are notified of a request of executing a ranging/sidelink positioning service, and a check result is provided for the AMF.

Step 307: If the request for executing the ranging/sidelink positioning service is approved in step 306, the AMF performs LMF selection in a case that the first terminal and the second terminal support the ranging/sidelink positioning service.

Step 308: The AMF sends a third request message to a selected LMF, where the third request message is used to request first configuration information of a first target object, and the first target object includes at least one of the first terminal or the second terminal. For example, the AMF invokes an Nlmf_Location_Determine ranging/sidelink positioning service operation to the LMF.

Step 309: After the LMF receives the third request message, the LMF controls the first terminal and the second terminal to perform a process related to the ranging/sidelink positioning service. At least one of the following processes may be included, for example:

The LMF obtains capability information of the first terminal and the second terminal that is associated with the ranging/sidelink positioning service, where the capability information is used to indicate whether the terminal supports the ranging/sidelink positioning service.

The LMF determines which one of the first terminal and the second terminal is an observation terminal, and which one is a target terminal.

The LMF determines first configuration information of the ranging/sidelink positioning service, and sends the first configuration information to the first terminal and the second terminal, where the first configuration information may be Positioning Reference Signal (PRS) configuration information.

The LMF calculates a ranging/sidelink positioning service result between the first terminal and the second terminal, to obtain a ranging/sidelink positioning result.

Step 310: The LMF sends a ranging/sidelink positioning result to the AMF. For example, after the ranging/sidelink positioning service is executed, the LMF returns an Nlmf_Location_Determine ranging/sidelink positioning response to the AMF, to return a ranging/sidelink positioning result between the first terminal and the second terminal.

Step 311: The AMF returns the ranging/sidelink positioning result between the first terminal and the second terminal to the GMLC.

Step 312: The GMLC sends a first request response message to the target service device by using the NEF, and adds the ranging/sidelink positioning result between the first terminal and the second terminal to the first request response message.

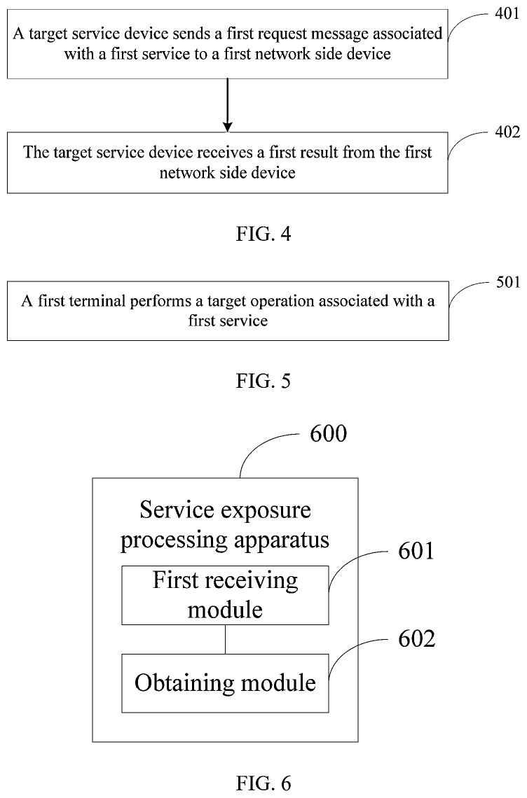

As shown in FIG. 4, an embodiment of this application further provides a service exposure processing method. As shown in FIG. 4, the service exposure processing method includes the following steps:

Step 401: A target service device sends a first request message associated with a first service to a first network side device, where the first service includes at least one of a ranging service or a sidelink positioning service.

Step 402: The target service device receives a first result from the first network side device, where the first result is a result of executing the first service by a first terminal and a second terminal.

In some embodiments, after the target service device sends the first request message associated with the first service to the first network side device, the method further includes:

the target service device receives a first request response message from the first network side device, where the first request response message is used to indicate an authentication result for the first request message.

In some embodiments, the method further includes:

the target service device sends first configuration information to a first target object based on the first request response message, where the first target object includes at least one of the first terminal or the second terminal, and the first configuration information is used by the first target object to execute the first service.

In some embodiments, the first configuration information includes at least one of the following:
reference signal information;
algorithm information;
service information;
a reference signal sending manner; and
a manner of determining a target result, where the target result is the first result or is determined based on the first result, and the target result includes at least one of the following: a relative distance between the first terminal and the second terminal, a relative angle between the first terminal and the second terminal, location information of the first terminal, or location information of the second terminal.

In some embodiments, the reference signal sending manner includes at least one of the following:
the first terminal sends a reference signal;
the second terminal sends a reference signal;
the first terminal and the second terminal send a reference signal;
a reference signal is sent immediately;
a reference signal is sent periodically; or sending of a reference signal is triggered by an event.

In some embodiments, the determining manner of the target result includes at least one of the following:
the first terminal determines the target result;
the second terminal determines the target result;
the first terminal and the second terminal determine the target result;
the first network side device determines the target result; or
the target service device determines the target result.

In some embodiments, the first request message is used to request at least one of the following:

obtaining the first result;
obtaining location information of the first terminal;
obtaining location information of the second terminal;
obtaining privacy information of the first terminal that is associated with the first service;
obtaining privacy information of the second terminal that is associated with the first service;
triggering the first terminal to execute the first service;
triggering the second terminal to execute the first service;
triggering the first terminal to obtain the first result; or
triggering the second terminal to obtain the first result.

In some embodiments, the first request message includes at least one of the following: a terminal identifier of the first terminal, a terminal identifier of the second terminal, first indication information, second indication information, first service-related requirement information, or quality of service QoS information, where the first indication information is used to indicate that the first request message is used to request to obtain the first result, the second indication information is used to indicate a terminal that initiates the first service, and the requirement information includes at least one of the following: precision of the first result or a type of the first service.

In some embodiments, the first result includes at least one of the following: a relative distance between the first terminal and the second terminal, a relative angle between the first terminal and the second terminal, location information of the first terminal, location information of the second terminal, or a second result, where the second result is an observation result obtained by the first terminal and/or the second terminal for a reference signal related to the first service.

In some embodiments, the second result includes at least one of first measurement information or second measurement information, the first measurement information is measurement information obtained, based on a second reference signal sent by the second terminal, by the first terminal when the first terminal executes the first service, and the second measurement information is measurement information obtained, based on a first reference signal sent by the first terminal, by the second terminal when the second terminal executes the first service.

In some embodiments, in a case that the first result is the second result, the method further includes:

the target service device obtains at least one of the following through calculation based on the second result:
the relative distance between the first terminal and the second terminal;
the relative angle between the first terminal and the second terminal;
the location information of the first terminal; or the location information of the second terminal.

As shown in FIG. 5, an embodiment of this application further provides a service exposure processing method. As shown in FIG. 5, the service exposure processing method includes the following steps:

Step 501: A first terminal performs a target operation associated with a first service, where the target operation includes at least one of the following:
in a case that the first terminal is an observation terminal, the target operation includes: receiving a first reference signal from a second terminal, and obtaining second information based on the first reference signal, where the first reference signal is used to determine measurement information; or
in a case that the first terminal is a target terminal, the target operation includes: sending a second reference signal to a second terminal, where the second reference signal is used to determine measurement information; where
the second information is used to determine a first result, the first result is a result of executing the first service by the first terminal and the second terminal, and the second information includes the measurement information or a measurement result obtained through calculation based on the measurement information.

In some embodiments, the target operation further includes: the first terminal sends the second information to a first network side device.

In some embodiments, the measurement result includes at least one of the following:
a relative distance between the first terminal and the second terminal;
a relative angle between the first terminal and the second terminal;
location information of the first terminal; or
location information of the second terminal.

In some embodiments, before the first terminal performs the target operation associated with the first service, the method further includes:

the first terminal receives first configuration information from a first network side device or a target service device, where the first configuration information is used by the first terminal to execute the first service.

In some embodiments, the first configuration information includes at least one of the following:
reference signal information;
algorithm information;
service information;
a reference signal sending manner; or
a manner of determining a target result, where the target result is the first result or is determined based on the first result, and the target result includes at least one of the following: a relative distance between the first terminal and the second terminal, a relative angle between the first terminal and the second terminal, location information of the first terminal, or location information of the second terminal.

In some embodiments, the reference signal sending manner includes at least one of the following:
the first terminal sends a reference signal;
the second terminal sends a reference signal;
the first terminal and the second terminal send a reference signal;
a reference signal is sent immediately;
a reference signal is sent periodically; or
sending of a reference signal is triggered by an event.

In some embodiments, the determining manner of the target result includes at least one of the following:
the first terminal determines the target result;
the second terminal determines the target result;
the first terminal and the second terminal determine the target result;
the first network side device determines the target result; or
the target service device determines the target result.

In some embodiments, before the first terminal performs the target operation associated with the first service, the method further includes:
the first terminal receives a second request message from a first network side device, where the second request message is used to determine whether the first terminal allows a first behavior; and
the first terminal sends a second request response message to the first network side device, where the second request response message is used to determine whether the first terminal allows the first behavior; where the first behavior includes at least one of the following:
the first terminal and the second terminal execute the first service;
a target device obtains location information of a terminal;
a target device triggers a terminal to execute the first service; or
a target device obtains privacy information of a terminal that is associated with the first service.

In some embodiments, before the first terminal performs the target operation associated with the first service, the method further includes:
the first terminal receives second configuration information from a first network side device, where the second configuration information is used to instruct to execute at least one of parameter information or authorization information used in a process associated with the first service.

In some embodiments, the method further includes:
the first terminal sends first information to a first network side device, where the first information includes at least one of the following: third indication information, auxiliary information of the first terminal that is associated with the first service, and a terminal identifier of the first terminal, where the third indication information is used to indicate at least one of the following:
a target device is allowed or not allowed to obtain location information of the first terminal;
a target device is allowed or not allowed to trigger the first terminal to execute the first service;
a target device is allowed or not allowed to trigger the first terminal to obtain the second information; or
a target device is allowed or not allowed to obtain privacy information of the first terminal that is associated with the first service.

In some embodiments, the first information is carried by using any one of the following non-access stratum NAS messages: a registration request message, a terminal configuration update message, a protocol data unit PDU session establishment message, a PDU session modification message, and a service request message.

In some embodiments, the auxiliary information includes at least one of the following: location information, address information, security information, reference signal information, measurement requirement information, capability information used to indicate whether the first service is supported, or algorithm information associated with the first service.

In some embodiments, the privacy information includes at least one of fourth indication information and a privacy type, and the fourth indication information is used to indicate at least one of the following:
the target device is allowed or not allowed to obtain the location information of the first terminal;
the target device is allowed or not allowed to trigger the first terminal to execute the first service;
the target device is allowed or not allowed to trigger the first terminal to obtain the second information; or
the target device is allowed or not allowed to obtain privacy information of the observation terminal that is associated with the first service.

The service exposure processing method provided in the embodiments of this application may be performed by a service exposure processing apparatus. In the embodiments of this application, a service exposure processing apparatus provided in the embodiments of this application is described by using an example in which the service exposure processing apparatus performs the service exposure processing method.

As shown in FIG. 6, an embodiment of this application provides a service exposure processing apparatus, applied to a first network side device. As shown in FIG. 6, the service exposure processing apparatus 600 includes:
a first receiving module 601, configured to receive a target request message associated with a first service, where the first service includes at least one of a ranging service or a sidelink positioning service; and
an obtaining module 602, configured to obtain a first result, where the first result is a result of executing the first service by a first terminal and a second terminal.

In some embodiments, the service exposure processing apparatus 600 further includes:
a first sending module, configured to send first configuration information to a first target object based on the target request message, where the first target object includes at least one of the first terminal or the second terminal, and the first configuration information is used by the first target object to execute the first service.

In some embodiments, the first configuration information includes at least one of the following:
reference signal information;
algorithm information;
service information;
a reference signal sending manner; or
a manner of determining a target result, where the target result is the first result or is determined based on the first result, and the target result includes at least one of the following: a relative distance between the first terminal and the second terminal, a relative angle between the first terminal and the second terminal, location information of the first terminal, or location information of the second terminal.

In some embodiments, the reference signal sending manner includes at least one of the following:
the first terminal sends a reference signal;
the second terminal sends a reference signal;
the first terminal and the second terminal send a reference signal;
a reference signal is sent immediately;
a reference signal is sent periodically; or
sending of a reference signal is triggered by an event.

In some embodiments, the determining manner of the target result includes at least one of the following:
the first terminal determines the target result;
the second terminal determines the target result;
the first terminal and the second terminal determine the target result;
the first network side device determines the target result; or
a target service device determines the target result.

In some embodiments, the first receiving module 601 is configured to receive a first request message from a target service device; where
the target request message is the first request message, and the first request message is used to request at least one of the following:
obtaining the first result;
obtaining location information of the first terminal;
obtaining location information of the second terminal;
obtaining privacy information of the first terminal that is associated with the first service;
obtaining privacy information of the second terminal that is associated with the first service;
triggering the first terminal to execute the first service;
triggering the second terminal to execute the first service;
triggering the first terminal to obtain the first result; or
triggering the second terminal to obtain the first result.

In some embodiments, the service exposure processing apparatus 600 further includes:
a first sending module, configured to send a second request message to a first target object, where the first target object includes at least one of the first terminal or the second terminal, and the second request message is used to determine whether the first target object allows a first behavior; where
the first receiving module 601 is further configured to separately receive a second request response message sent by the first target object; and
a first determining module, configured to determine, based on the second request response message, whether the first target object allows the first behavior; where
the first behavior includes at least one of the following:
the first terminal and the second terminal execute the first service;
a target device obtains location information of a terminal;
a target device triggers a terminal to execute the first service; or
a target device obtains privacy information of a terminal that is associated with the first service.

In some embodiments, the service exposure processing apparatus 600 further includes:
a first sending module, configured to send second configuration information to a first target object, where the first target object includes at least one of the first terminal or the second terminal, and the second configuration information is used to instruct to execute at least one of parameter information or authorization information used in a process associated with the first service.

In some embodiments, the first request message includes at least one of the following:
a terminal identifier of the first terminal, a terminal identifier of the second terminal, first indication information, second indication information, first service-related requirement information, and quality of service QoS information, where the first indication information is used to indicate that the first request message is used to request to obtain the first result, the second indication information is used to indicate a terminal that initiates the first service, or the requirement information includes at least one of the following: precision of the first result or a type of the first service.

In some embodiments, the service exposure processing apparatus 600 further includes:
a first sending module, configured to send a first request response message to the target service device, where the first request response message is used to indicate an authentication result for the first request message.

In some embodiments, in a case that the first network side device is a location management function LMF, the first receiving module 601 is configured to receive a third request message from an access and mobility management function AMF, where the target request message is the third request message, the third request message is used to request first configuration information of a first target object, and the first target object includes at least one of the first terminal or the second terminal.

In some embodiments, the third request message includes at least one of the following: a terminal identifier of the first terminal, a terminal identifier of the second terminal, capability information of the first terminal, or capability information of the second terminal, where
the capability information is used to indicate whether a terminal supports the first service.

In some embodiments, the service exposure processing apparatus 600 further includes:
a first determining module, where the first network side device determines an observation terminal and/or a target terminal; where
the observation terminal is a terminal that obtains the first result, the observation terminal includes at least one of the first terminal or the second terminal, the target terminal is a terminal that sends a reference signal, and the target terminal includes at least one of the first terminal or the second terminal.

In some embodiments, the first determining module is configured to determine the observation terminal and/or the target terminal based on target information, where
the target information includes at least one of the following: subscription information of a terminal, reachability of a terminal, capability information used to indicate whether a terminal supports the first service, location information of a terminal, or second indication information sent by a target service device, where the second indication information is used to indicate a terminal that initiates the first service.

In some embodiments, the service exposure processing apparatus 600 further includes:
a first sending module, configured to send a fourth request message to a first target object, where the first target object includes at least one of the first terminal or the second terminal, and the fourth request message is used to obtain at least one of the following:
the capability information;
the location information; or
requirement information related to the first service, where the requirement information includes at least one of the following: precision of the first result or a type of the first service.

In some embodiments, the service exposure processing apparatus 600 further includes a first sending module, configured to perform any one of the following:
sending the first result to a target service device; and
in a case that the first network side device is an LMF, sending the first result to a target service device by using a second network side device, where the second network side device includes an access and mobility management function AMF, a gateway mobile location center GMLC, and a network exposure function NEF.

In some embodiments, the first result includes at least one of the following: a relative distance between the first terminal and the second terminal, a relative angle between the first terminal and the second terminal, location information of the first terminal, location information of the second terminal, or a second result, where the second result is an observation result obtained by the first terminal and/or the second terminal for a reference signal related to the first service.

In some embodiments, the second result includes at least one of first measurement information or second measurement information, the first measurement information is measurement information obtained, based on a second reference signal sent by the second terminal, by the first terminal when the first terminal executes the first service, and the second measurement information is measurement information obtained, based on a first reference signal sent by the first terminal, by the second terminal when the second terminal executes the first service.

In some embodiments, the first receiving module 601 is further configured to receive first information from a first target object, where the first information includes at least one of the following: third indication information, auxiliary information of a second target object that is associated with the first service, or a terminal identifier of the second target object, where the first target object includes at least one of the first terminal or the second terminal, the second target object is a first terminal or a second terminal in the first target object, and the third indication information is used to indicate at least one of the following:
a target device is allowed or not allowed to obtain location information of the second target object;
a target device is allowed or not allowed to trigger the second target object to execute the first service;
a target device is allowed or not allowed to trigger the second target object to obtain second information, where the second information is used to determine the first result; or
a target device is allowed or not allowed to obtain privacy information of the second target object that is associated with the first service.

In some embodiments, the first information is carried by using any one of the following non-access stratum NAS messages: a registration request message, a terminal configuration update message, a protocol data unit PDU session establishment message, a PDU session modification message, and a service request message.

In some embodiments, the auxiliary information includes at least one of the following: location information, address information, security information, reference signal information, measurement requirement information, capability information used to indicate whether the first service is supported, or algorithm information associated with the first service.

In some embodiments, the privacy information includes at least one of fourth indication information or a privacy type, and the fourth indication information is used to indicate at least one of the following:
the target device is allowed or not allowed to obtain the location information of the second target object;
the target device is allowed or not allowed to trigger the second target object to execute the first service;
the target device is allowed or not allowed to trigger the second target object to obtain the second information, where the second information is used to determine the first result; or
the target device is allowed or not allowed to obtain the privacy information of the second target object that is associated with the first service.

In some embodiments, the obtaining module 602 is configured to: receive second information, and determine the first result based on the second information; where
the second information includes at least one of the following:
first measurement information or a first measurement result, where the first measurement information is measurement information obtained, based on a second reference signal sent by the second terminal, by the first terminal when the first terminal executes the first service, and the first measurement result is a result obtained through calculation based on the first measurement information; or
second measurement information or a second measurement result, where the second measurement information is measurement information obtained, based on a first reference signal sent by the first terminal, by the second terminal when the second terminal executes the first service, and the second measurement result is a result obtained through calculation based on the second measurement information.

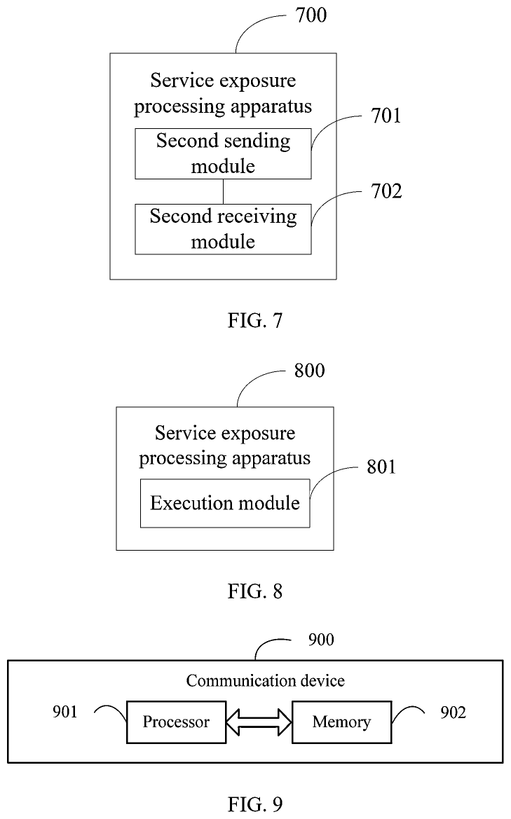

As shown in FIG. 7, an embodiment of this application provides a service exposure processing apparatus. As shown in FIG. 7, the service exposure processing apparatus 700 includes:
a second sending module 701, configured to send a first request message associated with a first service to a first network side device, where the first service includes at least one of a ranging service or a sidelink positioning service; and
a second receiving module 702, configured to receive a first result from the first network side device, where the first result is a result of executing the first service by a first terminal and a second terminal.

In some embodiments, the second receiving module 702 is further configured to receive a first request response message from the first network side device, where the first request response message is used to indicate an authentication result for the first request message.

In some embodiments, the second sending module 701 is further configured to send first configuration information to a first target object based on the first request response message, where the first target object includes at least one of the first terminal or the second terminal, and the first configuration information is used by the first target object to execute the first service.

In some embodiments, the first configuration information includes at least one of the following:
reference signal information;
algorithm information;
service information;
a reference signal sending manner; or
a manner of determining a target result, where the target result is the first result or is determined based on the first result, and the target result includes at least one of the following: a relative distance between the first terminal and the second terminal, a relative angle between the first terminal and the second terminal, location information of the first terminal, or location information of the second terminal.

In some embodiments, the reference signal sending manner includes at least one of the following:
the first terminal sends a reference signal;
the second terminal sends a reference signal;
the first terminal and the second terminal send a reference signal;
a reference signal is sent immediately;
a reference signal is sent periodically; or
sending of a reference signal is triggered by an event.

In some embodiments, the determining manner of the target result includes at least one of the following:
the first terminal determines the target result;
the second terminal determines the target result;
the first terminal and the second terminal determine the target result;
the first network side device determines the target result; or
the target service device determines the target result.

In some embodiments, the first request message is used to request at least one of the following:
obtaining the first result;
obtaining location information of the first terminal;
obtaining location information of the second terminal;
obtaining privacy information of the first terminal that is associated with the first service;
obtaining privacy information of the second terminal that is associated with the first service;
triggering the first terminal to execute the first service;
triggering the second terminal to execute the first service;
triggering the first terminal to obtain the first result; or
triggering the second terminal to obtain the first result.

In some embodiments, the first request message includes at least one of the following: a terminal identifier of the first terminal, a terminal identifier of the second terminal, first indication information, second indication information, first service-related requirement information, or quality of service QoS information, where the first indication information is used to indicate that the first request message is used to request to obtain the first result, the second indication information is used to indicate a terminal that initiates the first service, and the requirement information includes at least one of the following: precision of the first result or a type of the first service.

In some embodiments, the first result includes at least one of the following: a relative distance between the first terminal and the second terminal, a relative angle between the first terminal and the second terminal, location information of the first terminal, location information of the second terminal, or a second result, where the second result is an observation result obtained by the first terminal and/or the second terminal for a reference signal related to the first service. In some embodiments, the second result includes at least one of first measurement information or second measurement information, the first measurement information is measurement information obtained, based on a second reference signal sent by the second terminal, by the first terminal when the first terminal executes the first service, and the second measurement information is measurement information obtained, based on a first reference signal sent by the first terminal, by the second terminal when the second terminal executes the first service.

In some embodiments, in a case that the first result is the second result,
the apparatus obtains at least one of the following through calculation based on the second result:
the relative distance between the first terminal and the second terminal;
the relative angle between the first terminal and the second terminal;
the location information of the first terminal; or
the location information of the second terminal.

As shown in FIG. 8, an embodiment of this application provides a service exposure processing apparatus, applied to a first terminal. As shown in FIG. 8, the service exposure processing apparatus 800 includes:
an execution module 801, configured to perform a target operation associated with a first service, where the target operation includes at least one of the following:
in a case that the first terminal is an observation terminal, the target operation includes: receiving a first reference signal from a second terminal, and obtaining second information based on the first reference signal, where the first reference signal is used to determine measurement information; or
in a case that the first terminal is a target terminal, the target operation includes: sending a second reference signal to a second terminal, where the second reference signal is used to determine measurement information; where
the second information is used to determine a first result, the first result is a result of executing the first service by the first terminal and the second terminal, and the second information includes the measurement information or a measurement result obtained through calculation based on the measurement information.

In some embodiments, the target operation further includes: the first terminal sends the second information to a first network side device.

In some embodiments, the measurement result includes at least one of the following:
a relative distance between the first terminal and the second terminal;
a relative angle between the first terminal and the second terminal;
location information of the first terminal; or
location information of the second terminal.

In some embodiments, the service exposure processing apparatus 800 further includes:
a third receiving module, configured to receive first configuration information from a first network side device or a target service device, where the first configuration information is used by the first terminal to execute the first service.

In some embodiments, the first configuration information includes at least one of the following:
reference signal information;
algorithm information;
service information;
a reference signal sending manner; or
a manner of determining a target result, where the target result is the first result or is determined based on the first result, and the target result includes at least one of the following: a relative distance between the first terminal and the second terminal, a relative angle between the first terminal and the second terminal, location information of the first terminal, or location information of the second terminal.

In some embodiments, the reference signal sending manner includes at least one of the following:
the first terminal sends a reference signal;
the second terminal sends a reference signal;
the first terminal and the second terminal send a reference signal;
a reference signal is sent immediately;
a reference signal is sent periodically; or
sending of a reference signal is triggered by an event.

In some embodiments, the determining manner of the target result includes at least one of the following:
the first terminal determines the target result;
the second terminal determines the target result;
the first terminal and the second terminal determine the target result;
the first network side device determines the target result; or
the target service device determines the target result.

In some embodiments, the service exposure processing apparatus 800 further includes:
a third receiving module, configured to receive a second request message from a first network side device, where the second request message is used to determine whether the first terminal allows a first behavior; and
a third sending module, configured to send a second request response message to the first network side device, where the second request response message is used to determine whether the first terminal allows the first behavior; where
the first behavior includes at least one of the following:
the first terminal and the second terminal execute the first service;
a target device obtains location information of a terminal;
a target device triggers a terminal to execute the first service; or
a target device obtains privacy information of a terminal that is associated with the first service.

In some embodiments, the service exposure processing apparatus 800 further includes:
a third receiving module, configured to receive second configuration information from a first network side device, where the second configuration information is used to instruct to execute at least one of parameter information or authorization information used in a process associated with the first service.

In some embodiments, the service exposure processing apparatus 800 further includes:
a third sending module, configured to send first information to a first network side device, where the first information includes at least one of the following: third indication information, auxiliary information of the first terminal that is associated with the first service, or a terminal identifier of the first terminal, and the third indication information is used to indicate at least one of the following:
a target device is allowed or not allowed to obtain location information of the first terminal;
a target device is allowed or not allowed to trigger the first terminal to execute the first service;
a target device is allowed or not allowed to trigger the first terminal to obtain the second information; or
a target device is allowed or not allowed to obtain privacy information of the first terminal that is associated with the first service.

In some embodiments, the first information is carried by using any one of the following non-access stratum NAS messages: a registration request message, a terminal configuration update message, a protocol data unit PDU session establishment message, a PDU session modification message, and a service request message.

In some embodiments, the auxiliary information includes at least one of the following: location information, address information, security information, reference signal information, measurement requirement information, capability information used to indicate whether the first service is supported, or algorithm information associated with the first service.

In some embodiments, the privacy information includes at least one of fourth indication information and a privacy type, and the fourth indication information is used to indicate at least one of the following:
the target device is allowed or not allowed to obtain the location information of the first terminal;
the target device is allowed or not allowed to trigger the first terminal to execute the first service;
the target device is allowed or not allowed to trigger the first terminal to obtain the second information; or
the target device is allowed or not allowed to obtain privacy information of the observation terminal that is associated with the first service.

The service exposure processing apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11. Another device may be a server, a network attached storage (Network Attached Storage, NAS), or the like. This is not specifically limited in this embodiment of this application.

The service exposure processing apparatus provided in the embodiments of this application can implement the processes implemented in the method embodiments in FIG. 2 to FIG. 5, and a same technical effect is achieved. To avoid repetition, details are not described herein again.

In some embodiments, as shown in FIG. 9, an embodiment of this application further provides a communication device 900, including a processor 901 and a memory 902, and the memory 902 stores a program or an instruction that can be run on the processor 901. For example, in a case that the communication device 900 is a terminal, when the program or the instruction is executed by the processor 901, the steps of the foregoing embodiment of the service exposure processing method shown in FIG. 5 are implemented, and a same technical effect can be achieved.

In a case that the communication device 900 is a network side device, when the program or the instruction is executed by the processor 901, the processes of the foregoing embodiments of the service exposure processing methods in FIG. 2 and FIG. 4 are implemented, and a same technical effect is achieved. To avoid repetition, details are not described herein again.

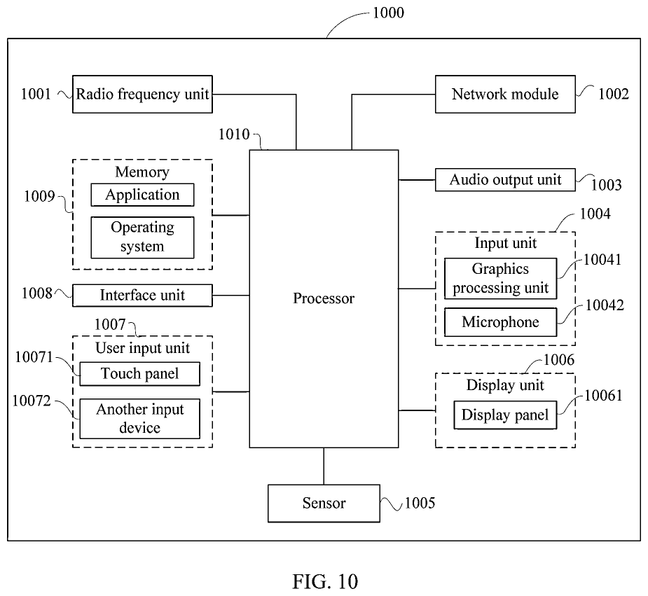

An embodiment of this application further provides a terminal. The terminal is a first terminal, and includes a processor and a communication interface. The communication interface is configured to perform a target operation associated with a first service, where the target operation includes at least one of the following: in a case that the first terminal is an observation terminal, the target operation includes: receiving a first reference signal from a second terminal, obtaining measurement information, and sending second information to a first network side device; or in a case that the first terminal is a target terminal, the target operation includes: sending a second reference signal to a second terminal, where the second reference signal is used to determine measurement information; and triggering the second terminal to send second information, where the second information is used to determine a first result, the first result is a result of executing the first service by the first terminal and the second terminal, and the second information includes the measurement information or a measurement result obtained through calculation based on the measurement information. The terminal embodiment is corresponding to the terminal side method embodiment, each implementation process and implementation of the method embodiment can be applied to the terminal embodiment, and a same technical effect can be achieved. For example, FIG. 10 is a schematic diagram of a hardware structure of a terminal according to an embodiment of this application.

The terminal 1000 includes but is not limited to at least a part of components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art may understand that the terminal 1000 may further include a power supply (such as a battery) that supplies power to each component. The power supply may be logically connected to the processor 1010 by using a power supply management system, to implement functions such as charging and discharging management, and power consumption management by using the power supply management system. The terminal structure shown in FIG. 10 constitutes no limitation on the terminal, and the terminal may include more or fewer components than those shown in the figure, or combine some components, or have different component arrangements. Details are not described herein.

It should be understood that in this embodiment of this application, the input unit 1004 may include a Graphics Processing Unit (GPU) 10041 and a microphone 10042. The graphics processing unit 10041 processes image data of a static picture or a video obtained by an image capture apparatus (for example, a camera) in a video capture mode or an image capture mode. The display unit 1006 may include a display panel 10061, and the display panel 10061 may be configured in a form of a liquid crystal display, an organic light-emitting diode, or the like. The user input unit 1007 includes at least one of a touch panel 10071 or another input device 10072. The touch panel 10071 is also referred to as a touchscreen. The touch panel 10071 may include two parts: a touch detection apparatus and a touch controller. The another input device 10072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1001 may transmit the downlink data to the processor 1010 for processing. In addition, the radio frequency unit 1001 may send uplink data to the network side device. Generally, the radio frequency unit 1001 includes but is not limited to an antenna, an amplifier, a transceiver, a coupler, a low noise amplifier, a duplexer, and the like.

The memory 1009 may be configured to store a software program or an instruction and various data. The memory 1009 may mainly include a first storage area for storing a program or an instruction and a second storage area for storing data. The first storage area may store an operating system, and an application or an instruction required by at least one function (for example, a sound playing function or an image playing function). In addition, the memory 1009 may be a volatile memory or a non-volatile memory, or the memory 1009 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a (Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM), and a Direct Rambus RAM (DRRAM). The memory 1009 in this embodiment of this application includes but is not limited to these memories and any memory of another proper type.

The processor 1010 may include one or more processing units. In some embodiments, an application processor and a modem processor are integrated into the processor 1010. The application processor mainly processes an operating system, a user interface, an application, or the like. The modem processor mainly processes a wireless communication signal, for example, a baseband processor. It may be understood that, for example, the modem processor may not be integrated into the processor 1010.

The radio frequency unit 1001 is configured to perform a target operation associated with a first service, where the target operation includes at least one of the following:
in a case that the first terminal is an observation terminal, the target operation includes: receiving a first reference signal from a second terminal, obtaining measurement information, and sending second information to a first network side device; or
in a case that the first terminal is a target terminal, the target operation includes: sending a second reference signal to a second terminal, where the second reference signal is used to determine measurement information; and triggering the second terminal to send second information; where
the second information is used to determine a first result, the first result is a result of executing the first service by the first terminal and the second terminal, and the second information includes the measurement information or a measurement result obtained through calculation based on the measurement information.

In this embodiment of this application, the first network side device may expose a ranging service and a sidelink positioning service for an application server or an application function.

An embodiment of this application further provides a network side device, including a processor and a communication interface. The communication interface is configured to receive a target request message associated with a first service, where the first service includes at least one of a ranging service or a sidelink positioning service. The processor is configured to obtain a first result, where the first result is a result of executing the first service by a first terminal and a second terminal. For example, the communication interface is configured to: send a first request message associated with a first service to a first network side device, where the first service includes at least one of a ranging service or a sidelink positioning service; and receive a first result from the first network side device, where the first result is a result of executing the first service by a first terminal and a second terminal. This embodiment on the network side device is corresponding to the foregoing method embodiment of the network side device. Each implementation process and implementation of the foregoing method embodiment may be applicable to this embodiment on the network side device, and a same technical effect can be achieved.

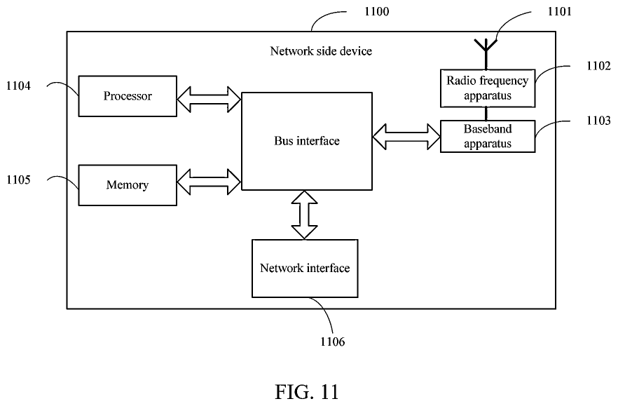

For example, an embodiment of this application further provides a network side device. As shown in FIG. 11, the network side device 1100 includes an antenna 1101, a radio frequency apparatus 1102, a baseband apparatus 1103, a processor 1104, and a memory 1105. The antenna 1101 is connected to the radio frequency apparatus 1102. In an uplink direction, the radio frequency apparatus 1102 receives information by using the antenna 1101, and sends the received information to the baseband apparatus 1103 for processing. In a downlink direction, the baseband apparatus 1103 processes information that needs to be sent, and sends processed information to the radio frequency apparatus 1102. The radio frequency apparatus 1102 processes the received information, and sends processed information by using the antenna 1101.

In the foregoing embodiment, the method performed by the network side device may be implemented in a baseband apparatus 1103. The baseband apparatus 1103 includes a baseband processor.

For example, the baseband apparatus 1103 may include at least one baseband board. A plurality of chips are disposed on the baseband board. As shown in FIG. 11, one chip is, for example, a baseband processor, and is connected to the memory 1105 by using a bus interface, to invoke a program in the memory 1105 to perform the operations of the network device shown in the foregoing method embodiment.

The network side device may further include a network interface 1106, and the interface is, for example, a common public radio interface (common public radio interface, CPRI).

For example, the network side device 1100 in this embodiment of the present disclosure further includes an instruction or a program that is stored in the memory 1105 and that can be run on the processor 1104, and the processor 1104 invokes the instruction or the program in the memory 1105 to perform the methods performed by the modules shown in FIG. 6 to FIG. 7, and a same technical effect is achieved. To avoid repetition, details are not described herein again.

An embodiment of this application further provides a readable storage medium. A program or an instruction is stored in the readable storage medium. When the program or the instruction is executed by a processor, the processes of the foregoing embodiment of the service exposure processing method can be implemented, and a same technical effect can be achieved. To avoid repetition, details are not described herein.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing embodiment of the service exposure processing method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product, the computer program/program product is stored in a storage medium, and the computer program/program product is executed by at least one processor to implement the processes of the foregoing embodiment of the service exposure processing method, and a same technical effect can be achieved. To avoid repetition, details are not described herein again.

An embodiment of this application further provides a communication system, including a terminal, a network side device, and a target service device. The terminal is configured to perform the processes in FIG. 5 and the foregoing method embodiments, the network side device is configured to perform the processes in FIG. 2 and the foregoing method embodiments, and the target service device is configured to perform the processes in FIG. 4 and the foregoing method embodiments. A same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is an example implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

1. A service exposure processing method, comprising:
receiving, by a first network side device, a target request message associated with a first service, wherein the first service comprises at least one of a ranging service or a sidelink positioning service; and
obtaining, by the first network side device, a first result, wherein the first result is a result of executing the first service by a first terminal and a second terminal.

2. The method according to claim 1, wherein before the obtaining, by the first network side device, a first result, the method further comprises:
sending, by the first network side device, first configuration information to a first target object based on the target request message, wherein the first target object comprises at least one of the first terminal or the second terminal, and the first configuration information is used by the first target object to execute the first service.

3. The method according to claim 1, wherein the receiving, by a first network side device, a target request message associated with a first service comprises:
receiving, by the first network side device, a first request message from a target service device, wherein
the target request message is the first request message, and the first request message is used to request at least one of the following:
obtaining the first result;
obtaining location information of the first terminal;
obtaining location information of the second terminal;
obtaining privacy information of the first terminal that is associated with the first service;
obtaining privacy information of the second terminal that is associated with the first service;
triggering the first terminal to execute the first service;
triggering the second terminal to execute the first service;
triggering the first terminal to obtain the first result; or
triggering the second terminal to obtain the first result.

4. The method according to claim 3, wherein after the receiving, by the first network side device, a first request message from a target service device, the method further comprises:
sending, by the first network side device, a second request message to a first target object, wherein the first target object comprises at least one of the first terminal or the second terminal, and the second request message is used to determine whether the first target object allows a first behavior;
receiving, by the first network side device, a second request response message sent by the first target object; and
determining, by the first network side device based on the second request response message, whether the first target object allows the first behavior;
wherein, the first behavior comprises at least one of the following:
the first terminal and the second terminal execute the first service;
a target device obtains location information of a terminal;
a target device triggers a terminal to execute the first service; or
a target device obtains privacy information of a terminal that is associated with the first service.

5. The method according to claim 3, wherein after the receiving, by the first network side device, a first request message from a target service device, the method further comprises:
sending, by the first network side device, second configuration information to a first target object, wherein the first target object comprises at least one of the first terminal or the second terminal, and the second configuration information is used to instruct to execute at least one of parameter information or authorization information used in a process associated with the first service.

6. The method according to claim 3, wherein the first request message comprises at least one of the following:
a terminal identifier of the first terminal, a terminal identifier of the second terminal, first indication information, second indication information, first service-related requirement information, or Quality of Service (QOS) information, wherein the first indication information is used to indicate that the first request message is used to request to obtain the first result, the second indication information is used to indicate a terminal that initiates the first service, and the requirement information comprises at least one of the following: precision of the first result or a type of the first service.

7. The method according to claim 3, wherein after the receiving, by the first network side device, a first request message from a target service device, the method further comprises:
sending, by the first network side device, a first request response message to the target service device, wherein the first request response message is used to indicate an authentication result for the first request message.

8. The method according to claim 1, wherein when the first network side device is a Location Management Function (LMF), the receiving, by a first network side device, a target request message associated with a first service comprises:
receiving, by the first network side device, a third request message from an access and Mobility Management Function (AMF), wherein the target request message is the third request message, the third request message is used to request first configuration information of a first target object, and the first target object comprises at least one of the first terminal or the second terminal.

9. The method according to claim 1, wherein after the receiving, by a first network side device, a target request message associated with a first service, the method further comprises:
determining, by the first network side device, an observation terminal or a target terminal, wherein the observation terminal is a terminal that obtains the first result, the observation terminal comprises at least one of the first terminal or the second terminal, the target terminal is a terminal that sends a reference signal, and the target terminal comprises at least one of the first terminal or the second terminal.

10. The method according to claim 1, wherein after the obtaining, by the first network side device, a first result, the method further comprises any one of the following:
sending, by the first network side device, the first result to a target service device; or
when the first network side device is an LMF, sending, by the first network side device, the first result to a target service device by using a second network side device, wherein the second network side device comprises an access and AMF, a Gateway Mobile Location Center (GMLC), and a Network Exposure Function (NEF).

11. The method according to claim 1, further comprising:
receiving, by the first network side device, first information from a first target object, wherein the first information comprises at least one of the following: third indication information, auxiliary information of a second target object that is associated with the first service, or a terminal identifier of the second target object, wherein the first target object comprises at least one of the first terminal or the second terminal, the second target object is a first terminal or a second terminal in the first target object, and the third indication information is used to indicate at least one of the following:
a target device is allowed or not allowed to obtain location information of the second target object;
a target device is allowed or not allowed to trigger the second target object to execute the first service;
a target device is allowed or not allowed to trigger the second target object to obtain second information, wherein the second information is used to determine the first result; or
a target device is allowed or not allowed to obtain privacy information of the second target object that is associated with the first service.

12. A service exposure processing method, comprising:
sending, by a target service device, a first request message associated with a first service to a first network side device, wherein the first service comprises at least one of a ranging service or a sidelink positioning service; and
receiving, by the target service device, a first result from the first network side device, wherein the first result is a result of executing the first service by a first terminal and a second terminal.

13. The method according to claim 12, wherein after the sending, by a target service device, a first request message associated with a first service to a first network side device, the method further comprises:
receiving, by the target service device, a first request response message from the first network side device, wherein the first request response message is used to indicate an authentication result for the first request message.

14. The method according to claim 12, wherein the first request message is used to request at least one of the following:
obtaining the first result;
obtaining location information of the first terminal;
obtaining location information of the second terminal;
obtaining privacy information of the first terminal that is associated with the first service;
obtaining privacy information of the second terminal that is associated with the first service;
triggering the first terminal to execute the first service;
triggering the second terminal to execute the first service;
triggering the first terminal to obtain the first result; or
triggering the second terminal to obtain the first result.

15. The method according to claim 12, wherein the first request message comprises at least one of the following:
a terminal identifier of the first terminal, a terminal identifier of the second terminal, first indication information, second indication information, first service-related requirement information, or QoS information, wherein the first indication information is used to indicate that the first request message is used to request to obtain the first result, the second indication information is used to indicate a terminal that initiates the first service, and the requirement information comprises at least one of the following: precision of the first result or a type of the first service.

16. The method according to claim 12, wherein the first result comprises at least one of the following: a relative distance between the first terminal and the second terminal, a relative angle between the first terminal and the second terminal, location information of the first terminal, location information of the second terminal, or a second result, wherein the second result is an observation result obtained by the first terminal or the second terminal for a reference signal related to the first service.

17. A service exposure processing method, comprising:
performing, by a first terminal, a target operation associated with a first service, wherein the target operation comprises at least one of the following:
when the first terminal is an observation terminal, the target operation comprises: receiving a first reference signal from a second terminal, and obtaining second information based on the first reference signal, wherein the first reference signal is used to determine measurement information; or
when the first terminal is a target terminal, the target operation comprises: sending a second reference signal to a second terminal, wherein the second reference signal is used to determine measurement information;
wherein the second information is used to determine a first result, the first result is a result of executing the first service by the first terminal and the second terminal, and the second information comprises the measurement information or a measurement result obtained through calculation based on the measurement information.

18. The method according to claim 17, wherein the measurement result comprises at least one of the following:
a relative distance between the first terminal and the second terminal;
a relative angle between the first terminal and the second terminal;
location information of the first terminal; or
location information of the second terminal.

19. The method according to claim 17, wherein before the performing, by a first terminal, a target operation associated with a first service, the method further comprises:
receiving, by the first terminal, a second request message from a first network side device, wherein the second request message is used to determine whether the first terminal allows a first behavior; and
sending, by the first terminal, a second request response message to the first network side device, wherein the second request response message is used to determine whether the first terminal allows the first behavior;
wherein the first behavior comprises at least one of the following:
the first terminal and the second terminal execute the first service;
a target device obtains location information of a terminal;
a target device triggers a terminal to execute the first service; or
a target device obtains privacy information of a terminal that is associated with the first service.

20. The method according to claim 17, wherein before the performing, by the first terminal, the target operation associated with the first service, the method further comprises:
receiving, by the first terminal, second configuration information from a first network side device, wherein the second configuration information is used to instruct to execute at least one of parameter information or authorization information used in a process associated with the first service.
